(19) United States
(12) Patent Application Publication
(10) Pub. No.: US 2003/0227004 A1
(43) Pub. Date: Dec. 11, 2003

(54) Clear neon aerosol paint

(76) Inventor: Daniel A. Dopps, Wichita, KS (US)

Correspondence Address: Bradley P. Sylvester, Exchange Place, 225 North Market, Suite 100, Wichita, KS, 67202, US

(21) Appl. No.: 10/164,689

(22) Filed: Jun. 6, 2002

(51) Int. Cl. C09K 11/02; C08K 5/05

(52) U.S. Cl. 252/301.36; 524/379

(57) ABSTRACT

An aerosol composition, and the method of making the same, having flourescent pigments, suitable for spray application to a substrate surface and rapid air drying, where said spray application is transparent when applied, and also when dried, but where the pigments will reflect visible light under long wave uv or black light exposure. This aerosol composition is removable using soap and water, making this composition useful in numerous settings where a nonpermanent paint is desired. The paint is virtually invisible following application, but appears to brilliantly glow under black light exposure, creating a medium suitable for artistic endeavors. The composition comprises at least one alcohol, comprising 30 to about 40 percent by weight of the total aerosol composition, a polymer resin, comprising an acrylic copolymer, comprising 5 to 10 percent by weight of the total aerosol composition, a propellant, comprising 40 to 60% by weight of the total aerosol composition, pigment, comprising 0.5 to about 5 percent weight of the total aerosol composition; and also comprising 0.05-0.15% of the total weight of the aerosol composition, AMP aminomethylpropanol neutralizer, which assists the aerosol composition in moving from a dried state into a solution of water during a removal process.

### DESCRIPTION OF THE PRIOR ART

Aerosol paints tend to fall in two general categories, in relation to the novelty asserted in the present application. The first type of paint is one that is aqueous, or water based. In some of these paints, the water content comprises a significantly high percentage by volume and/or weight, in order to allow the paint to be either nonflammable, or to allow the paint and pigmentation to have a liquid consistency capable of being used in an aerosol container. Other types of paint are created using non aqueous substances, without any water being used in the mixture. These paints are typically intended as a permanent application. Perhaps most significantly, the pigments are also visible under ordinary lighting conditions.

Typical aerosol paint, as reflected in the various patents discussed below, have a significant amount of pigments that are visible to the naked eye after application. The various component parts of the paint contribute to either the suspension of the pigments, the pH control in the container, or as anti-foaming agents or drying agents. Some of the prior art describes a gloss, or transparent layer being applied to give items a “shiny” look. A lacquer-like finish is the result of leaving out the pigments, with the non pigmented paint providing a permanent layer or protection.

Referring to U.S. Pat. No. 4,265,797 (Suk), an example of the prior art regarding aerosol water-based paint compositions is shown. The primary thrust of this patent appears to be toward the reduction in the level of volatile organic solvents. A significant amount of water is used, as shown in an example 1 and example 2, especially when the W.L. 91 emulsion is considered, that has approximately 58 percent water. This particular paint appears to take approximately 20 minutes to dry under ordinary circumstances, and is in fact water resistant after three hours. This particular paint is somewhat impervious to attempts at removal. The current invention proposed in the present application allows the alcohol to evaporate rapidly, thus allowing the present invention to the dry within the matter of a minute or two, but which is still able to be easily removed using ordinary soap and water.

Referring now to U.S. Pat. No. 4,482,662 (Rapaport et al.), this patent discloses a pigmented paint or clear varnish that is able to be sprayed on to a surface, using an aerosol delivery system. In this particular patent, the dimethyl ether is indicated as comprising 25-50% of the total weight of the paint. Unlike the present invention, water functions as a co-solvent with the propellant dimethyl ether, along with volatile alcohols and ketones while they are in a pressurized state. Rapaport et al. indicates that water comprises 20 to 40% of the total products. Rapaport et al. also indicates that a clear coating may be obtained, in which there is no pigmentation. Inert pigments having a low index of refraction are suggested as being usable in small amounts to create a dull film layer. The amount of pigments used by weight is significant in this patent, with a large amount of water being used as well. Also of significance, the amount of dimethyl ether appears to be approaching 40 to 50 percent of the total volume, depending on the color, and seems to be in a similar proportion with the water.

Referring now to U.S. Pat. No. 5,348,992 (Pearson et al.), an aerosol paint composition, containing non-aqueous dispersions. These non-aqueous dispersions are used as the principal resins in the aerosol paint formulation. This particular patent deals with the composition of the resins, and not the complete mixture used in an aerosol dispensing system.

Referring now to U.S. Pat. No. 5,988,455 (Pearson, et al.) a water-based

aerosol paint compositions is disclosed. The amount of propellant used is disclosed as being between 25 percent to 50 percent by weight, with the primary ingredient being the Joncryl 537 Latex Resin, as indicated in example 1. The amount of Isopropanol is significantly less in the Pearson et al. invention than the present invention. Pearson et al. uses only 5 percent by weight Isopropanol, which is significantly less than the 12 to 25% that would normally be used in the present invention.

### SUMMARY OF THE INVENTION

The present invention attempts to avoid being seen at all, except under certain conditions utilizing particular light wavelengths, being the longer uv or those emitted by a typical blacklight. The pigments in the present invention are not seen by the naked eye under ordinary conditions, but have fluorescent properties, which allow them to appear to glow when in contact with certain light wavelengths, such as those emitted by a typical “black light”.

The present invention, is unique in relation to other prior art, in that fluorescent particles, or what is also termed “pigment” in this invention, is mixed with a solvent and carrier means. The present invention is intended to be applied as an aerosol paint, but unlike the prior art shown, it is not intended to be a permanent application. The present invention describes a transparent substance containing fluorescence particles, that even after it has been applied and allowed to dry fully, is both virtually invisible and readily removed using simply water and an ordinary detergent.

The present invention is intended to provide a user with the ability to spray paint a surface, using the combination of substances provided and described in the application. Once the paint is applied, it is virtually undetectable because it is completely clear, and does not even give a significantly glossy type finish. It is only when the proper wavelengths of light are shined upon it, that the pigment particles contained therein, will fluorescence, and appear to glow.

A further benefit of the present invention as an aerosol application, is that the pigment particles are dispersed on the surface to which they are applied, with a higher concentration of particles available in the central portion of the application, with the surrounding edges having a decreasing level of flourescent particles, so that the appearance of glowing is enhanced by the presence of scattered additional pigment particles surrounding the area of higher concentration of pigment particles, thereby enhancing the appearance of the glowing area. This present invention allows artistic applications not previously available. This aerosol application further provides the means to accent and highlight three-dimensional surfaces, and also allowing the texture of the surface to be effective in the distribution of the fluorescent particles of pigment, so that the texture attributes are highlighted in a manner caused by fluorescent particles being gathered or more concentrated together in depression or other grooves on the textured surface.

The paint that is disclosed in the present application has a particular use as an artistic manner to accent three-dimensional objects, but is also usable in many other situations. Because it is easily removable, this paint can be used as a temporary marker on the particular object, while leaving the object to have the appearance of being free from any external markings under typical light conditions.

Accordingly, it is the object of this invention to provide an aerosol paint that is virtually invisible under ordinary light conditions, but which has pigments contained within it that appear fluorescent when exposed to long wave uv or typical blacklight emissions.

Accordingly, it is a further object of this invention to provide an aerosol paint that is capable of being safely applied to wall surfaces, such as interior walls, clothing, and even skin surfaces, without causing permanent staining, and which is removable using ordinary soap and water.

Accordingly, it is a further object of this invention to provide a fluorescent aerosol paint that is able to be used in a novel artistic manner, through the dispersal of fluorescent pigment particles over rough and/or uneven surfaces.

Accordingly, is a further object of this invention to provide a novel method for the mixing and preparation of a non aqueous aerosol fluorescent paint.

### DETAILED DESCRIPTION OF THE INVENTION

A polymer resin is selected, that is capable of being able to dry following application, so that it is clear or transparent. Said polymer resin is placed into a mixing container. Once in the mixing container, the resin is subjected to the agitation of a high-speed mixer, or any mixing means commonly known and understood in the art. While the mixing means is in operation, the desired alcohol is added slowly, preferably at a uniform rate, so as to allow ubiquitous and uniform mixing. The mixer may continue to agitate these two ingredients, once the alcohol is fully added, to ensure complete uniformity in the mixture ratio of polymer resin and alcohol throughout the combined mixture. Once it is determined that these two ingredients are fully blended, a selected fluorescent pigment is added to the mixture. The pigments are obtained in a solid powder form, which have preferably been milled to a size smaller than 10 microns for dispersion and maximum fluorescence.

The pigments may be natural mineral compounds, or those that are man made and are

generally nontoxic. Examples of various pigments, which comprise those from the following group, that would create what is generally considered white, to white with a slight bluish tint, comprise: agate, albite, aragonite, barite, brucite, calcite, celestite, cerussite, colemanite, cowlesite, datolite, diopside, dypintite, eucryptite, flourite, gowerite, gypsum, halite, hanksite, hemimorphite, hydroboracite, laumontite, magnesite, mesolite, meyerofferite, natrolite, pectolite, pirssonite, smithsonite, stilbite, strontianite, thaumasite, thomsonite, trona, ulexite, wavellite, whewellite, witherite, wollastonite and xonotlite.

Pigments that give a reddish tint, comprise those selected from the following group, anthophyllite, axinite, barite, calcite, corundum, halite, sphalerite and tirodite.

Pigments that give an orangish color comprise those selected from the group comprising: alunite, amber, amblygonite, apatite, barite, becquerelite, boltwoodite, calcite, caloimel, cerrussite, chondrodite, clinohedrite, gaylussite, margarosanite, montebrasite, pectolite, phosphuranylite, scapolite, scheelinte, sodalite, soddylite, sphalerite, tremolite, walstromite, willemite, wollastonite, wulfenite, wurtziste and zircon.

Pigments that give a yellow color comprise those selected from the group comprising: agate, analcime, andersonite, anglesite, apatite, aphthitalite, apoplyllite, aragonite, barite, cahnite, calcite, celestite, cerussite, colemanite, diopside, espertite, fluorite, foshagite, gypsum, hanksite, hemimorphite, idrialite, laumontite, melanophlogite, nahcolite, norbergite, plombierite, powellite, pyrophyllite, rosenhahnite, scapolite, scheelite, serpentine, sphalerite, spodumene, strontianite, talc, tremolite, trona, ulexite, uralolite, wavellite, witherite, wollanstonite, zincite, and zircon.

Pigments that give a greenish color comprise those selected from the group comprising: adamite, agate, aragonite, autunite, calcite, meta-autunite, opal, quartz, uranocircite, urannopilite, willemite, and zippeite.

Pigments that give a bluish to lavender color comprise the group comprising: albite, apatite, barite, benitoite, brucite, calcite, celestite, colemanite, creedite, dypingite, fluorite, gypsum, hardystonite, hedyphane, herdite, howlite, hydrozincite, karpatite, magnesite, margarite, microcline, pectolite, scapolite, sphalerite, strontianite, tyuyamunite, wavellite, witherite, and wollastonite.

Typically, the mixing process will take 15 minutes of constant mixing until the three ingredients are properly mixed with one another, Once they are suitably mixed, the mixture comprises the actual pigment delivery liquid. This liquid mixture is put into aerosol cans. The propellant is also added, giving the aerosol can, or similar delivery system, the ability to eject the polymer/alcohol/pigment mixture out of the aerosol delivery system.

The amount of the polymer resin, comprising an acrylic copolymer, preferably comprises 5 to 10 percent by weight of the total aerosol composition when fully mixed. Subjection of this resin to a rapid agitation, such as provided through a high speed mixer, or similar mixing means, begins to stir the resin. Alcohol is slowly added to the agitating resin in a slow and uniform manner, to allow proper uniform mixing. Isopropyl alcohol is the typical alcohol used, but the mixture may use at least any one alcohol of the formula R—OH, wherein R is an unsubstituted straight or branched chain alkyl group, comprising 30 to about 40 percent by weight of the total aerosol composition.

A flourescent pigment, that is in powder form, and which has been preferably milled to 10 microns or less in diameter size, is added to the alcohol/resin mixture. The pigment mass comprises 0.5 to about 5 percent weight of the total aerosol composition. The pigments must be added slowly, and be mixed thoroughly and uniformly, so as to have a proper distribution within the resin/alcohol mixture.

Where the aerosol mixture is intended to be non-permanent, so that it can be easily removed with soap and water, AMP aminomethylpropanol neutralizer is also added to the mixture in a negligible quantity of only 0.05-0.15% of the total weight of the aerosol composition. This neutralizer assists the aerosol composition in moving from a dried state into a solution of water during a removal process, thus allowing soap and water to remove the dried aerosol from a surface, into a solution of water.

When all of the above components are fully mixed, the mixture is placed into an aerosol can, or similar aerosol deliver system, along with a propellant, comprising 40 to 60% by weight of the total aerosol composition.

Table A gives the various range of mass of each of the various ingredients for this novel flourescent paint, in proportion to the total mass of the mixture and propellant combination.

TABLE A

| | |
|---|---|
| 30-40% | IPA alcohol (solvent) |
| 5-10% | Acrylic Copolymer |
| 40-60% | Propellant (DME propane butane) |
| 0.5-5% | Flourescent Pigment |
| .15% | AMP aminomethylpropanol neutralizer |

This fluorescent mixture, when applied using an aerosol delivery system, allows the user to enhance the various surfaces to which it is applied in a novel manner. For example, because this fluorescent mixture is not of a permanent nature, and that it is able to be readily removed using simple soap and water, this fluorescent mixture may be applied safely to clothing, skin, and even hair. On certain types of clothing, the fluorescent mixture will be able to dry without any noticeable change in appearance to the clothing. Similarly, when the fluorescent mixture is applied to hair, and/or skin, once the fluorescent mixture has dried, it will be for the most part unnoticeable. Then, when the surface which has had the fluorescent mixture applied, is subjected to the typical black light, the fluorescent particles will appear to glow.

The aerosol delivery system allows the fluorescent pigments to be dispersed in an artistic manner. This is dependent on the spray, as well as the surface to which the fluorescent mixture is applied. A typical atomizer spray nozzle will tend to concentrate a greater proportion of the spray in a centralized area. Generally, the farther the distance from the center of a spray, the greater the decrease in fluorescent mixture application. This of course results in a diminished amount of fluorescent pigments being dispersed as the distance from the center of a spray area increases. An example of the value of this application technique, is suitably shown when a spray is concentrated in a centralized region on a three-dimensional tube. The central area of the spray applied, has a greater concentration of fluorescent particles than the fringe areas of the spray. If the fluorescent particles are selected due to their propensity to emit a glow that appears to be reddish, the manner in which the fluorescent mixture is applied, will be quite similar in appearance to a glowing wood ember, when subjected to typical black light. In fact, if using several different pigments within the reddish to orange to yellow range of color, a very realistic glowing fire may be created under black light conditions.

When the surface to which the fluorescent mixture is applied is rough, or has various depressions defined in its surface, these depressions will generally have an increased level of particulate fluorescent manner deposited within them. Whereas typical ordinary spray paint only provides a coating of a desired color, the typical spray paint is unable to artistically define definition to a three-dimensional surface, since the typical spray paint only allows a single color to be applied, and a thin coat of typical spray paint generally has a similar appearance of a thicker coat of paint. The present invention can create substantial definition, due to the fact that the flourescent particles increase as to intensity when massed together. While the color may be somewhat uniform in a flourescent spray paint, the definition and intensity are much greater in appearance under a black light. The invention therefore has a unique and suitable use on walls, certain furniture, artistic objects, and organic surfaces.

From the foregoing statements, summary and description in accordance with the present invention, it is understood that the same are not limited thereto, but are susceptible to various changes and modifications as known to those skilled in the art and we therefore do not wish to be limited to the details shown and described herein, but intend to cover all such changes and modifications which would be encompassed by the scope of the appended claims.

I claim:

1. An aerosol composition having flourescent pigments, suitable for spray application to a substrate surface and rapid air drying, where said spray application is transparent when applied, and also when dried, but where the pigments will reflect visible light under long wave uv or black light exposure, and where the aerosol composition is removable using soap and water, said composition consists essentially of:
a. at least one alcohol of the formula: R—OH wherein R is an unsubstituted straight or branched chain alkyl group, comprising 30 to about 40 percent by weight of the total aerosol composition;
b. a polymer resin, comprising an acrylic copolymer, comprising 5 to 10 percent by weight of the total aerosol composition;
c. a propellant, comprising 40 to 60% by weight of the total aerosol composition;
d. pigment, comprising 0.5 to about 5 percent weight of the total aerosol composition; and
e. 0.05-0.15% of the total weight of the aerosol composition, AMP aminomethylpropanol neutralizer, which assists the aerosol composition in moving from a dried state into a solution of water during a removal process.

2. The composition of claim 1 wherein said alcohol is Isopropyl-40.

3. The composition of claim 1 wherein said propellant is dimethyl ether.

4. The composition of claim 1 wherein said propellant is butane.

5. The composition of claim 1 wherein said pigments comprise solid particles that have been milled to a size of 10 microns or less.

6. A method of making an aerosol composition having flourescent pigments, suitable for spray application to a substrate surface and rapid air drying, where said spray application is transparent when applied, and also when dried, but where the pigments will reflect visible light under long wave uv or black light exposure, and where the aerosol composition is removable using soap and water, said method of making comprising the following steps:
a. placing a polymer resin into a mixing container;
b. agitating the polymer resin using a mixing means;
c. adding a desired alcohol to the polymer resin in a manner that allows complete and uniform mixing; and
d. adding pigment to the polymer resin and alcohol mixture, during agitation supplied by a mixing means.

7. A method of making an aerosol composition having flourescent pigments, as recited in claim 6, where the alcohol is added slowly at a uniform rate.

8. A method of making an aerosol composition having flourescent pigments, as recited in claim 6, where the alcohol and resin continue to be blended during the addition of the pigments, and where said pigments are added slowly at a uniform rate.

9. A method of making an aerosol composition having flourescent pigments, as recited in claim 6, where the pigments are in a solid powder form, and are poured into the agitating mixture of alcohol and resin.

10. A method of making an aerosol composition having flourescent pigments, as recited in claim 6, in which the additional ingredient of AMP aminomethylpropanol neutralizer is added during the mixing process of the alcohol and resin, or of the alcohol/resin mixture and pigment mixing process.

11. A method of making an aerosol composition having flourescent pigments, as recited
in claim 6, in which the mixing agitation will take 15 minutes of constant mixing once the addition of the alcohol and resin are added to each other, to ensure complete and uniform mixing.

12. A method of making an aerosol composition having flourescent pigments, as recited in claim 6, in which an additional step comprises of placing the finished mixture of into an aerosol delivery system, with a suitable propellant, after the alcohol, resin, and pigment are fully mixed.

13. A method of making an aerosol composition having flourescent pigments, as recited in claim 6, in which an additional step comprises of adding AMP aminomethylpropanol neutralizer during the mixing process of the pigments, alcohol and resin, and where said mixture is placed into an aerosol delivery system, with a suitable propellant, after the alcohol, resin, AMP aminomethylpropanol neutralizer, and pigment are fully mixed.
